(19) United States
(12) Patent Application Publication
(10) Pub. No.: US 2026/0152011 A1
(43) Pub. Date: Jun. 4, 2026

(54) METHOD AND COMPUTING DEVICE FOR DETERMINING A SET OF RASTER IMAGES FOR SWATHES TO BE PRINTED ON AN OBJECT

(71) Applicants: Airbus SAS, BLAGNAC (FR); Airbus Operations SAS, TOULOUSE (FR); Airbus Operations GmbH, HAMBURG (DE)

(72) Inventors: Matthias OTTO, HAMBURG (DE); Fabian MAHLER, HAMBURG (DE); Boris MORINIERE, ROCHEFORT (FR); Olivier BÜRGY, TOULOUSE (FR); Samuel LELEU, TOULOUSE (FR)

(21) Appl. No.: 19/406,327

(22) Filed: Dec. 2, 2025

(30) Foreign Application Priority Data
Dec. 4, 2024 (FR) FR2413432

(51) Int. Cl. B41J 3/407; B41J 2/045; B41J 2/11

(52) U.S. Cl. CPC B41J 3/4073; B41J 2/04526; B41J 2/11; B41J 2203/011

(57) ABSTRACT

A method for determining a set of raster images for swathes to be printed on an object using a printing system including at least one robot provided with a printing tool, which is configured to follow a set of trajectories, receives a mesh of the object, texture maps associated with this mesh and the trajectories to be followed by the robot, and it carries out, with the aid of a computing device, a simulation of a printing process taking account of aerodynamic effects on printing jets and it determines greyscales as a function of stitching situations between swathes relating to the trajectories, which makes it possible to obtain raster images capable of generating high quality printing even in the case of complex geometry and long projection distances.

### CROSS-REFERENCES TO RELATED APPLICATIONS

This application claims the benefit of French Patent Application Number FR2413432 filed on Dec. 4, 2024, the entire disclosure of which is incorporated herein by way of reference.

### FIELD OF THE INVENTION

The present invention relates to a method and a computing device for determining a set of raster images for swathes to be printed on an object.

### BACKGROUND OF THE INVENTION

The invention more specifically applies to the field of texture mapping, which involves applying two-dimensional texture data to a three-dimensional object. Texture mapping can be used for printing representations of colors, text, logos, images, artistic designs, etc., on the object. This object can be large, such as an airplane, for example, and can have one or more curved surfaces.

The printing is carried out using a printing system that prints directly onto the shape, known as “DTS Printing” (Direct-To-Shape Printing). Generally, such a printing system comprises at least one robot intended to follow a set of trajectories. The robot is equipped with a plurality of printing heads, each of which is equipped with a plurality of nozzles.

The present invention relates to a method for determining a set of raster images that can be used by such a printing system to print swathes on a three-dimensional object, with each swathe being obtained by the robot passing along a given trajectory.

Document EP 3208746 A1 describes a method for inkjet printing on a three-dimensional object. The printing method is defined to enable printing on a curved surface. However, the printing method described in this document does not address the problem of stitching between adjacent swathes, i.e., the partial overlap between two adjacent swathes. This problem therefore must be addressed on 2D images, as post-processing of the generated images. However, such processing is only possible for a simple stitching configuration.

Notably, if obstacles are present that affect the movement of the robot, such as, for example, an antenna on an area of an airplane fuselage to be printed, then complex division of the area to be printed into swathes is generally contemplated, as a result of this presence of obstacles and with the aim of reducing the unprinted area around the one or more obstacles. The complexity involved in printing increases when the area to be printed is curved.

Such a complex division of the swathes generates a wide variety of stitching situations, some of which are difficult or even impossible to manage with 2D post-processing of the generated swathes.

Therefore, a requirement exists for finding a solution that allows a set of raster images for swathes to be printed on an object to be determined accurately and relatively simply, taking into account all the stitching situations between the swathes and allowing high-quality printing to be provided, notably despite any complex geometry.

### SUMMARY OF THE INVENTION

An aim of the present invention is to propose such a solution. To this end, the present invention relates to a method for determining a set of raster images for swathes to be printed on an object (manufactured), with the printing having to be carried out using a printing system comprising at least one robot intended to follow a set of trajectories, the robot being equipped with a plurality of printing heads, each of which is equipped with a plurality of nozzles for printing jets at given spraying instants.

According to the invention, the method comprises at least the following successive steps:
a reception step for receiving a mesh of the object, corresponding to a tessellated mesh formed by triangles, texture maps associated with this mesh and the trajectories to be followed by the robot; and
a determination step for determining, based on the mesh, the texture maps and the trajectories, the set of raster images, by simulating a printing method taking into account aerodynamic effects on the printing jets and by determining greyscales as a function of stitching situations between swathes relating to the trajectories.

Thus, by virtue of the invention, the method allows a set of raster images for swathes to be printed on a manufactured object to be determined in a precise and relatively simple manner, taking into account all the stitching situations between the swathes and allowing high-quality printing to be provided despite complex geometry and also allowing long spraying distances, as specified hereafter.

In a preferred embodiment, the determination step comprises the following successive sub-steps:
a first sub-step for (digitally) simulating the printing method in order to determine, for each trajectory, each nozzle of each printing head and each spraying instant, the coordinates of a point of impact of a potential droplet on a triangle of the mesh and the identification of the triangle;
a second sub-step for identifying, in subdivided triangles of the mesh, a stitching situation based on the trajectories, for applying a stitching code relating to each stitching situation and for associating the stitching code with the texture map at the location corresponding to the coordinates of the considered subdivided triangle;
a third sub-step for analyzing the texture maps comprising all the stitching situations and the stitching codes and for associating each stitching situation with a stitching gradient for each of the successive swathes to be printed;
a fourth sub-step for determining, from among the potential droplets, the droplets that will be used, and for assigning a greyscale to each of the droplets that will be used; and
a fifth sub-step implemented for each trajectory and for each printing head, with this fifth sub-step incorporating, for each droplet that will be used that corresponds to this trajectory and to this printing head, the greyscale assigned thereto, in an initially empty raster image so as to obtain the raster image associated with this trajectory and with this printing head, with the set of raster images comprising the raster images thus obtained for all the trajectories and for all the printing heads.

Advantageously, the first sub-step comprises the following (successive) operations, for each trajectory, each nozzle of each printing head and each spraying instant:
spraying a printing jet from the nozzle perpendicular to a plate of the nozzle toward the mesh;
computing the point of intersection of the printing jet with the mesh; and
computing the point of impact corresponding to the point of impact of a potential droplet (or droplet opportunity), by applying a deviation to the point of intersection in a printing direction in order to take into account an aerodynamic deviation of the printing jet (or of the droplet) during spraying.

In addition, advantageously, the second sub-step comprises the following (successive) operations for each triangle of the mesh of the object:
subdividing the triangle into sub-triangles having a predetermined side length; and
for each sub-triangle:
   selecting all the potential droplets falling on this sub-triangle;
   identifying the stitching situation as a function of the number and the order of the various trajectories; and
   placing the stitching code in an added color layer corresponding to the stitching situation and associating it with the texture map at the location indicated by the coordinates of the sub-triangle.

Advantageously, subdividing the triangle into sub-triangles is carried out iteratively until a predetermined resolution is obtained.

Furthermore, advantageously, the third sub-step comprises the following (successive) operations:
analyzing the texture map containing all the stitching situations;
simplifying the stitching situations taken into account;
segmenting the texture map relative to the stitching codes; and
associating each stitching situation with the stitching gradient for each of the successive swathes to be printed.

Furthermore, advantageously, the fourth sub-step comprises the following (successive) operations for each triangle of the mesh of the object:
subdividing the triangle into sub-triangles having a predetermined side length;
determining, based on the texture map, an average target color to be applied to the sub-triangle and the stitching gradient to be applied to each swath; and

for each swath, determining, from among the potential droplets, which droplets will be used and assigning a greyscale to each of the droplets that will be used.

Furthermore, advantageously, the fifth sub-step comprises the following (successive) operations, for each trajectory and each printing head:
creating the empty raster image that includes a pixel height equal to the number of nozzles of the printing head and a pixel width equal to the duration of the trajectory multiplied by the ejection frequency or to the length of the trajectory; and
for each droplet relating to the trajectory and to the printing head, storing the greyscale in the raster image at the position corresponding to the nozzle and at the spraying instant so as to obtain the raster image associated with this trajectory, this printing head or the nozzle.

The present invention also relates to a computing device for determining a set of raster images for swathes to be printed on an object, with the printing having to be carried out using a printing system comprising at least one robot intended to follow a set of trajectories, the robot being equipped with a plurality of printing heads, each of which is equipped with a plurality of nozzles for printing jets at given spraying instants.

According to the invention, the device comprises at least:
a reception unit configured to receive a mesh of the object, corresponding to a tessellated mesh formed by triangles, texture maps associated with this mesh and the trajectories to be followed by the robot; and
a computing unit configured to determine, based on the mesh, the texture maps and the trajectories, the set of raster images, using a simulation of a printing method taking into account aerodynamic effects on the printing jets and by determining greyscales as a function of stitching situations between swathes relating to the trajectories.

### BRIEF DESCRIPTION OF THE DRAWINGS

The attached figures will assist in understanding how the invention can be implemented. In these figures, identical references designate similar elements.

FIG. 1 is a block diagram of a method for determining a set of raster images for swathes to be printed on a manufactured object.

FIG. 2 schematically shows a device configured to implement the method of FIG. 1.

FIG. 3 schematically shows a portion of an object associated with a tessellated mesh.

FIG. 4 is a schematic diagram of an example of a printing system capable of implementing direct-to-shape printing.

FIG. 5 schematically illustrates a stitching situation.

FIG. 6 is a schematic representation illustrating the determination of a point of contact when spraying from a nozzle.

### DETAILED DESCRIPTION OF THE PREFERRED EMBODIMENTS

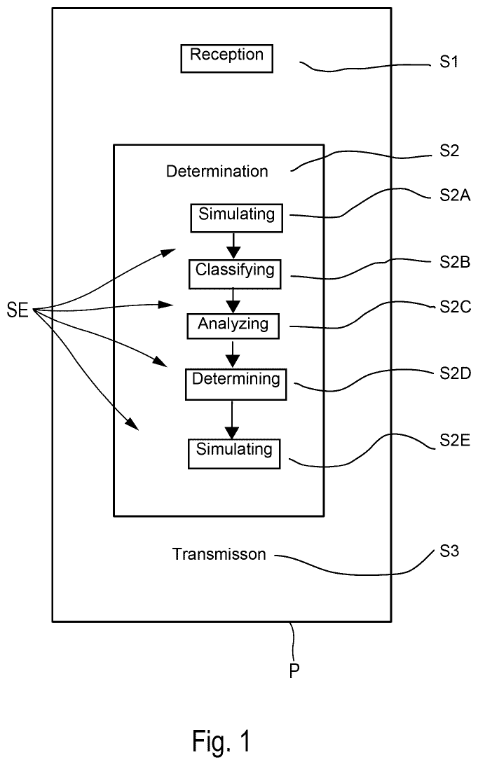

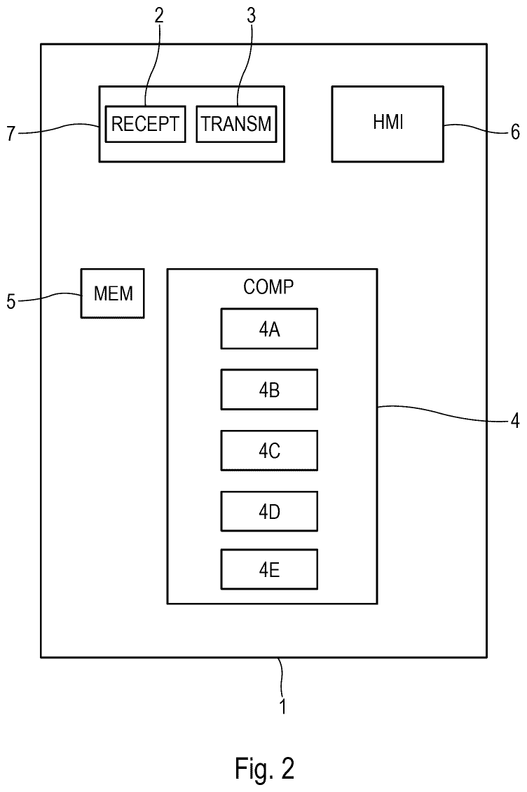

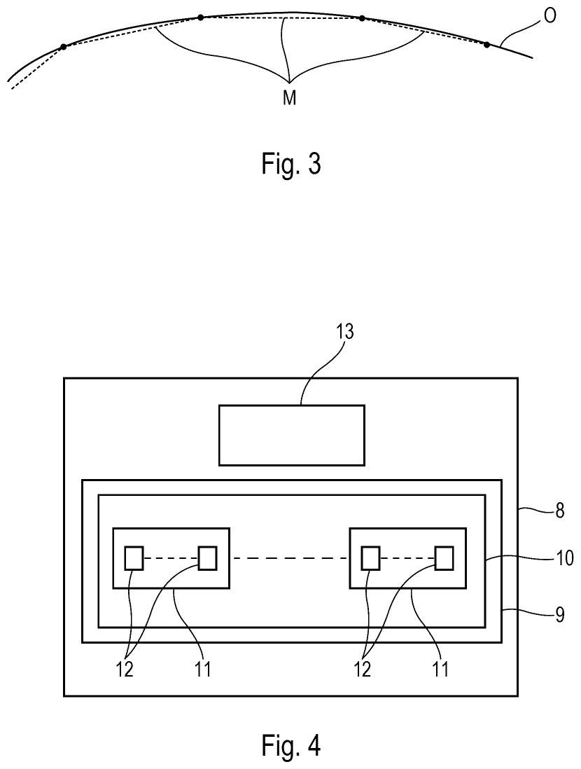

Within the scope of the present invention, a method P (for example, such as that shown in a particular embodiment in FIG. 1) that can be implemented by a computing device 1 (for example, such as that shown in a particular embodiment in FIG. 2) is intended to determine a set E of raster images IM for swathes to be printed on an object O (partially shown in FIG. 3) that has been manufactured.

These raster images IM are defined within the context of texture mapping, which involves applying two-dimensional (or 2D) texture data to a three-dimensional (or 3D) object, such as the object O. Texture mapping can be used to add representations to the object, notably colors, text, logos, images, artistic designs, etc.

Within the scope of the present invention, for the sake of simplification, the term “object” refers to any appliance, machine or other mechanical element or a portion of such an appliance, machine or other mechanical element whose surface or a portion of its surface is able to receive such printing. This can notably involve the fuselage of an airplane on which distinctive signs (logos, colors, etc.) of the airline operating the airplane are to be printed.

The raster images IM are intended to be used for “DTS Printing” (Direct-To-Shape Printing) technology, which allows direct printing on the three-dimensional surface of an object, irrespective of its shape.

The direct printing will be implemented using a printing system 8, for example, as is schematically shown in FIG. 4. This printing system 8 comprises at least one robot 9 intended to follow a set of trajectories TR. Within the scope of the present invention, the robot can be configured to perform any type of movement (linear movement, rotary movement, complex articulation, etc.) and can correspond, for example, to a robotic arm or a Cartesian gantry.

The robot 9 comprises a printing tool 10 (“printing end-effector”) at a free end. This printing tool 10 is equipped with a plurality of printing heads 11, for example, four printing heads, in a non-limiting example for each of the primary colors cyan, magenta, yellow and black. Each of these printing heads 11 is equipped with a plurality of nozzles 12, for example, more than a thousand nozzles, for generating printing jets (namely, ink droplet sprays) at given spraying instants.

The printing system 8 also comprises a control unit 13 notably intended to control the movement of the robot 9, generally a robotic arm, and the prints produced by the printing tool 10. The set E of raster images IM determined by the computing device 1 can be supplied, for example, to the control unit 13 of the printing system 8 for printing.

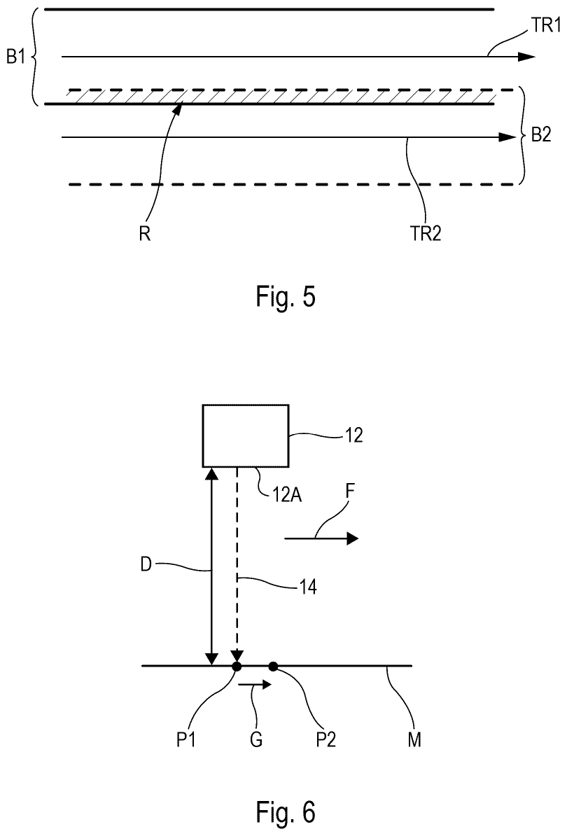

During printing, the printing tool 10 of the robot 9 is moved each time (i.e., for each pass) along a trajectory TR in order to print a swath each time, such as the swathes B1 and B2 shown by way of an illustration in FIG. 5. Each printed swath B1, B2 represents a portion of the livery, i.e., of the print to be produced.

The aim of the method P and of the computing device 1 notably is to take into account the stitching situations of such swathes, i.e., any overlaps of directly adjacent swathes.

FIG. 5 highly schematically shows a stitching situation R (illustrated by hatched areas indicating the overlapping area) between the swath B1, represented by thick lines, and the swath B2, represented by dashed lines.

Due to the presence of one or more potential obstacles on an area of the object to be printed, for example, an airplane antenna, and the need to reduce the unprinted area around the one or more obstacles, a complex division of the swathes (with varying shapes and/or sizes and/or orientations) is generally provided in order to maximize the printable area despite the limited accessibility of the printing tool 10.

This complex division of the swathes generates a wide variety of stitching situations, some of which are difficult or even impossible to manage with 2D post-processing of the generated swathes.

By way of an illustration, a plurality of different stitching situations can arise, notably due to:
swathes assuming different shapes (for example, straight swathes or curved swathes), different sizes and/or different orientations; and/or
for curved swathes, different areas to be printed for each color; and/or
partial overprinting on previously printed swathes (curved or straight), with or without any previously implemented stitching; and/or
the beginnings and/or ends of swathes, optionally linked to other swathes, with this notably being in different ways.

These different stitching situations therefore include different types of stitching (i.e., areas (where at least two swathes overlap) that assume different shapes and sizes).

As indicated above, the notable aim of the method P is to manage such stitching situations. To this end, the method P particularly comprises, as shown in FIG. 1, the following steps, implemented by the computing device 1:
a reception step S1 implemented by a reception unit 2 (RECEPT) of the computing device 1 (FIG. 2), for receiving at least:
   a mesh M of the manufactured object O, as is partially and schematically illustrated in FIG. 4, corresponding to a standard tessellated mesh formed by triangles;
   standard (two-dimensional) texture maps CT associated with this mesh M. These texture maps are of the HD (i.e., high resolution) type; and
   the trajectories TR that must be followed by the printing tool 10 of the robot 9 in order to print the various swathes;
a determination step S2 implemented by a computing unit 4 (COMP) of the computing device 1, for determining the set E of raster images IM, based on the mesh M, the texture maps CT and the trajectories TR, as specified hereafter. In particular, the determination step S2 carries out a (digital) simulation of a printing method, taking into account aerodynamic effects on printing jets, and determines greyscales as a function of stitching situations R (FIG. 5) between swathes relating to the trajectories TR; and
a transmission step [S3?] implemented by a transmission unit 3 (TRANSM) of the computing device 1, for transmitting this set E of raster images IM to a user device (not shown), for example, a computer or a control unit of the printing system 8 (such as the control unit 13 of FIG. 4).

As shown in FIG. 1, the determination step S2 comprises a sequence SE of successive sub-steps S2A to S2E.

The determination step S2 initially comprises the sub-step S2A, which is implemented by a computing element 4A of the computing unit 4, for simulating (digitally) a printing method.

In order to carry out this printing simulation, the computing element 4A determines data for each trajectory TR, for each nozzle 12 of each printing head 11 and for each spraying instant (i.e., a specific instant when a printing jet is generated from the nozzle 12), namely, the coordinates of a point of impact of a potential droplet (specified hereafter) on a triangle of the mesh M and the identification of this triangle.

This data is integrated into a table T. This table T is preferably stored in a memory of the computing device 1, for example, in a memory 5 (FIG. 2) or in a memory (not shown) of the computing unit 4.

In order to carry out this simulation of the printing method, the computing element 4A implements the following operations:
it selects and orders the trajectories TR of the printing tool 10 of the robot 9 in order to cover the livery;
it creates the empty table T for subsequently storing the data; and
for each trajectory TR, for each spraying instant (corresponding to a time step of the trajectory, sampled with the spraying frequency performed by the printing heads 11):
   it positions the printing tool 10 at a corresponding position (of the 6D type) relative to the tessellated mesh M of the object O. This position (of the 6D type) designates the location and the orientation of the printing tool 10 in (three-dimensional) space according to six degrees of freedom (with three degrees of freedom for translation and three degrees of freedom for rotation); and
   for each nozzle 12 of each printing head 11 for each spraying instant, it implements a sequence of operations.

This sequence of operations includes the following (successive) operations (therefore for each nozzle 12 of each printing head 11 for each spraying instant):
spraying a printing jet 14 from the nozzle 12 perpendicular to a plate 12A of the nozzle 12 toward the mesh M of the object, as is schematically shown in FIG. 6. The nozzle 12 is located at a distance D from the mesh that is, for example, greater than 5 mm (in the case of “DTS Printing” type printing) so that the printing jet becomes sensitive to aerodynamic effects, as specified hereafter;
computing the point of intersection P1 of the printing jet 14 with the mesh M; and
computing the point of impact P2 corresponding to the point of impact of a potential droplet (or droplet opportunity), by applying a deviation (illustrated by an arrow G in FIG. 5) to the point of intersection P1. This deviation for moving from the point of intersection P1 to the point of impact P2 is performed in a printing direction F (i.e., the direction of movement of the printing tool 10) in order to take into account an aerodynamic deviation (i.e., a deviation due to aerodynamic effects) of the droplet (or of the printing jet) during spraying.

Then, the computing element 4A adds a new row to the table T, which row stores the trajectory reference, the spraying instant, the reference of the printing head 11 (which corresponds to a color), the reference of the nozzle 12, the reference of the (impacted) triangle of the mesh M, and the coordinate of the point of impact P2 on this triangle. Within the scope of the present invention, the “reference” of an element is understood to mean any type of indication that allows this element to be identified.

The method P thus allows the aerodynamic effects in the placement of droplets to be taken into account and compensated. These aerodynamic effects are notably due to:
a significant spraying distance D (FIG. 6), for example, greater than 5 mm, in the case of direct printing of the “DTS Printing” type, which induces a significant transverse air flow, likely to deflect the actual movement of the droplets, compared to a straight printing jet 14; and
aerodynamic turbulence that can be generated between the nozzles 12 when several of them, which are close to each other, spray for a short period of time.

The determination step S2 then comprises the sub-step S2B implemented (after the sub-step S2A) by a computing element 4B of the computing unit 4, for classifying the stitching situations (between the swathes).

More specifically, in the sub-step S2B, the computing element 4B identifies, in subdivided triangles of the mesh M, a stitching situation based on the trajectories TR, then applies a stitching code relative to each stitching situation (i.e., a code that allows the type of stitching to be identified from among the various possible types) and associates the stitching code with the texture map CT, at the location corresponding to the coordinates of the considered subdivided triangle.

To this end, in the sub-step S2B, the computing element 4B carries out a plurality of operations for each triangle of the mesh M of the object O.

The computing element 4B initially subdivides the considered triangle into sub-triangles, which in turn are iteratively subdivided, and so on, until a desired appropriate size is obtained for the sub-triangles. To this end, preferably, each triangle, then each sub-triangle, is subdivided (iteratively) into four sub-triangles, and this continues until the sub-triangles (which preferably are equilateral) have a side length that is less than a predetermined value (representing a desired resolution), for example, 500 μm.

Then, for each sub-triangle (obtained by such subdivisions), the computing element 4B performs the following (successive) sequence of operations:
it selects all the potential droplets falling on this sub-triangle from the table T;
it identifies the stitching situation as a function of the number and the order of the various trajectories; and

it implements the stitching code in an added color layer, corresponding to the stitching situation, and it associates the stitching code with the texture map CT at the location indicated by the coordinates of the sub-triangle (for example, by storing the stitching code identifying the stitching situation in an additional dedicated “color” layer of the texture map CT).

The determination step S2 then comprises the sub-step S2C implemented (after the sub-step S2B) by a computing element 4C of the computing unit 4, to incorporate stitching gradients into the texture map CT.

More specifically, in the sub-step S2C, the computing element 4C analyzes the texture maps CT (as completed in sub-step S2B) comprising the stitching situations and the stitching codes, and associates a stitching gradient (or pattern) with each stitching situation for each of the successive swathes to be printed, with each of the swathes being associated with one of the trajectories TR.

For a given point (to be printed in the vicinity of a stitching) that is to receive a given overall volume of color (ink), the stitching gradient defines the percentage of this overall volume for each of the swathes involved in the stitching. For example, if the point is located at a stitching with two swathes, a given percentage of the color (for example, 80%, corresponding to the stitching gradient of the first swath) is deposited when passing through this point so as to form the first swath, and the remainder (20% in this example, corresponding to the stitching gradient of the second swath) is deposited when passing through this point so as to form the second swath.

To this end, in the sub-step S2C, the computing element 4C carries out the following operations:
it analyzes the texture map CT containing all the stitching situations;
it simplifies the stitching situations if possible. For example, a stitching situation between four different trajectories can be considered to be a stitching situation with only three trajectories, when considering that one of the four trajectories does not to contribute to this area;
it segments the texture map CT relative to the stitching codes; and
it associates each stitching situation with the stitching gradient (or pattern) for each of the successive swathes to be printed (i.e., for each of the successive passes).

The determination step S2 then comprises the sub-step S2D implemented (after the sub-step S2C) by a computing element 4D of the computing unit 4, in order to determine, from among the potential droplets, the droplets that will be used, and in order to assign a greyscale, which is stored in the table T, to each of the droplets that will be used.

To this end, in the sub-step S2D, the computing element 4D carries out a plurality of operations for each triangle of the mesh M of the object O.

The computing element 4D initially subdivides the triangle into sub-triangles, which in turn are iteratively subdivided, and so on, until a desired appropriate size is obtained for the sub-triangles. To this end, preferably, each triangle, then each sub-triangle, is subdivided (iteratively) into four sub-triangles, and this continues until the sub-triangles (which preferably are equilateral) have a side length that is less than a predetermined value (representing a desired resolution), for example, 500 μm.

The computing element 4D then carries out the following (successive) operations:
for each sub-triangle, where applicable, it determines, based on the texture map CT, an average target color to be applied to the sub-triangle and the stitching gradient to be applied to each swath; and
for each swath (i.e., each pass corresponding to a trajectory), it determines, from among the potential droplets, which droplets will be used, and assigns a greyscale to each of the droplets that will be used.

To this end, it implements an optimization approach in order to achieve color consistency and accuracy on the sub-triangle, based on the diameter of the dots (printed) and the ICC (International Color Consortium) profile, which defines how colors should be reproduced to ensure consistent and accurate color management. The ICC profile can be received during the reception step S1 and/or can be stored in a memory of the computing device 1 (for example, in the memory 5).

The greyscale thus determined is then stored in the table T.

Finally, the determination step S2 also comprises the sub-step S2E, implemented (after the sub-step S2D) by a computing element 4E of the computing unit 4, for determining a raster image IM, for each trajectory TR and for each printing head 11, i.e., for each pair comprising one of the initially received trajectories TR and one of the printing heads 11 of the printing system 8.

The raster images IM, which are obtained (in sub-step S2E) for all the pairs made up of a trajectory and a printing head, form the set E of raster images IM.

To this end, in the sub-step S2E, the computing element 4E incorporates, for each droplet in the table T corresponding to this trajectory TR and this printing head 11, the greyscale assigned thereto (in sub-step S2D) into a 2D raster image that is initially empty, in order to obtain the 2D raster image associated with this trajectory TR and this printing head 11 after taking into account all the corresponding droplets.

More specifically, in the sub-step S2E, the computing element 4D carries out the following operations for each trajectory TR and each printing head 11:
it creates the empty raster image IM (2D) that has a pixel height equal to the number of nozzles 12 of the printing head 11 and a pixel width equal to the duration of the trajectory TR multiplied by the spraying frequency (carried out from the printing head 11) or the length of the trajectory; and
for each droplet in the table T corresponding to the trajectory TR and the considered printing head 11, it stores the greyscale in the raster image IM at the position corresponding to the nozzle 12 and at the spraying instant, so as to obtain the raster image IM associated with this trajectory TR and this printing head 11.

Consequently, for a number N of trajectories TR and a number M of printing heads 11, the set E comprises N×M raster images ℑₙₘ, with n ranging between 1 and N and m ranging between 1 and M.

All the aforementioned processing, sub-steps and operations are digitally implemented by the computing device 1. No physical processing is carried out.

The computing device 1 can also comprise, as shown in FIG. 2:
at least one memory, such as the memory 5 (MEM), capable of storing data that is used for the data processing and the computations implemented by the computing elements of the computing device 1, such as, for example, the table T; and
a human-machine interface 6 (HMI) allowing an operator to supply data to the computing device 1, such as, for example, the predetermined value concerning the lengths of the sides of the subdivided triangles, which is used in sub-steps S2B and S2D.

In addition, the reception unit 2 and the transmission unit 3 can form part of a standard communication system 7 allowing the computing device 1 to communicate with devices outside the computing device 1, via a wired or wireless connection.

The various computing elements and/or computing units of the computing device 1 can correspond to any type of processor capable of implementing the corresponding processing and computations.

The method P and the computing device 1, as described above, thus allow raster images to be created for all the swathes to be printed along the trajectories of the robot, taking into account all the stitching situations between the swathes and providing high-quality printing despite complex geometry and long spraying distances.

More specifically, they thus notably allow:
very high precision to be achieved in terms of the positioning of the droplets and thus allow better color management to be provided and, as a result, allow color consistency and a sharper, more accurate print to be provided; and
by taking into account the stitching (3D), they allow complex stitching situations to be managed, which notably allows the area that can be printed (around obstacles) to be extended without generating visual defects.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for determining a set of raster images for swathes to be printed on an object, with the printing having to be carried out using a printing system comprising at least one robot configured to follow a set of trajectories, said robot being provided with a plurality of printing heads, each of which is equipped with a plurality of nozzles for printing jets at given spraying instants, said method being implemented by a computing device and comprising at least the following successive steps:
a reception step for receiving a mesh of the object, corresponding to a tessellated mesh formed by triangles, texture maps associated with this mesh and said set of trajectories to be followed by the robot; and
a determination step for determining, based on said mesh, said texture maps and said trajectories, said set of raster images, by simulating a printing method taking into account aerodynamic effects on the printing jets and by determining greyscales as a function of stitching situations between swathes relating to said trajectories, the determination step comprising at least the following sub-steps:
a second sub-step for identifying, in subdivided triangles of the mesh, a stitching situation based on said trajectories, for applying a stitching code relating to each stitching situation and for associating the stitching code with the texture map at a location corresponding to coordinates of each considered subdivided triangle; and
a third sub-step for analyzing the texture maps comprising all the stitching situations and the stitching codes and for associating each stitching situation with a stitching gradient for each successive swath to be printed.

2. The method as claimed in claim 1, wherein the determination step also comprises the following sub-steps:
a first sub-step for simulating a printing method in order to determine, for each trajectory, each nozzle of each printing head and each spraying instant, coordinates of a point of impact of each potential droplet on one of the triangles of said mesh and an identification of said one triangle;
a fourth sub-step for determining, from among the potential droplets, the droplets that will be used, and for assigning a greyscale to each of the droplets that will be used; and
a fifth sub-step implemented for each trajectory and for each printing head, with this fifth sub-step incorporating, for each droplet that will be used that corresponds to this trajectory and to this printing head, the greyscale assigned thereto, in an initially empty raster image so as to obtain a raster image associated with this trajectory and with this printing head, with said set of raster images comprising the raster images thus obtained for all the trajectories and for all the printing heads.

3. The method as claimed in claim 2, wherein the first sub-step comprises the following operations, for each trajectory, each nozzle of each printing head and each spraying instant:
spraying a printing jet from the nozzle perpendicular to a plate of the nozzle toward the mesh;
computing a point of intersection of the printing jet with the mesh; and
computing the point of impact corresponding to the point of impact of a potential droplet, by applying a deviation to the point of intersection in a printing direction in order to take into account an aerodynamic deviation of the printing jet during spraying.

4. The method as claimed in claim 2, wherein the second sub-step comprises the following operations for each of the triangles of the mesh of the object:
subdividing the triangle into sub-triangles having a predetermined side length; and
for each sub-triangle:
selecting all the potential droplets falling on this sub-triangle;
identifying the stitching situation as a function of a number and an order of various trajectories; and
placing the stitching code in an added color layer corresponding to the stitching situation and associating the stitching code with the texture map at the location indicated by coordinates of the sub-triangle.

5. The method as claimed in claim 2, wherein the third sub-step comprises the following operations:
analyzing the texture map containing all the stitching situations;
simplifying the stitching situations taken into account;
segmenting the texture map relative to the stitching codes; and
associating each stitching situation with the stitching gradient for each successive swath to be printed.

6. The method as claimed in claim 2, wherein the fourth sub-step comprises the following operations, for each of the triangles of the mesh of the object:
subdividing the triangle into sub-triangles having a predetermined side length;
determining, based on the texture map, an average target color to be applied to each sub-triangle and the stitching gradient to be applied to each swath; and
for each swath, determining, from among potential droplets, which droplets will be used and assigning a greyscale to each of the droplets that will be used.

7. The method as claimed in claim 2, wherein the fifth sub-step comprises the following operations, for each trajectory and each printing head:
creating the empty raster image that includes a pixel height equal to a number of nozzles of the printing head and a pixel width equal to a duration of the trajectory multiplied by an ejection frequency or to the length of the trajectory; and
for each droplet relating to the trajectory and to the printing head, storing the greyscale in the raster image at a position corresponding to the and at the spraying instant so as to obtain the raster image associated with this trajectory and this printing head.

8. The method as claimed in claim 4, wherein subdividing the triangle into sub-triangles is carried out iteratively until a predetermined resolution is obtained.

9. A computing device for determining a set of raster images for swathes to be printed on an object, with the printing having to be carried out using a printing system comprising at least one robot configured to follow a set of trajectories, said robot being provided with a plurality of printing heads, each of which is equipped with a plurality of nozzles for printing jets at given spraying instants, said computing device comprising:
a reception unit configured to receive a mesh of the object, corresponding to a tessellated mesh formed by triangles, texture maps associated with this mesh and said set of trajectories to be followed by the robot; and
a computing unit configured to determine, based on said mesh, said texture maps and said set of trajectories, said set of raster images, using a simulation of a printing method taking into account aerodynamic effects on the printing jets and by determining greyscales as a function of stitching situations between swathes relating to said trajectories, the computing unit comprising:
a computing element configured to identify, in subdivided triangles of the triangles of the mesh, a stitching situation based on said trajectories, for applying a stitching code relating to each stitching situation and for associating the stitching code with the texture map at a location corresponding to coordinates of a considered subdivided triangle; and
a computing element configured to analyze the texture maps comprising all the stitching situations and the stitching codes and for associating each stitching situation with a stitching gradient for each successive swath to be printed.
